(19) United States
(12) Patent Application Publication
(10) Pub. No.: US 2023/0140665 A1
(43) Pub. Date: May 4, 2023

(54) SYSTEMS AND METHODS FOR CONTINUOUS USER AUTHENTICATION BASED ON BEHAVIORAL DATA AND USER-AGNOSTIC PRE-TRAINED MACHINE LEARNING ALGORITHMS

(71) Applicant: TYPINGDNA INC., Brooklyn, NY (US)

(72) Inventor: Raul-Laviniu POPA, Brooklyn, NY (US)

(21) Appl. No.: 18/050,207

(22) Filed: Oct. 27, 2022

Related U.S. Application Data
(60) Provisional application No. 63/274,818, filed on Nov. 2, 2021.

(51) Int. Cl. H04L 9/40

(52) U.S. Cl. CPC H04L 63/0861

(57) ABSTRACT

Disclosed herein are methods, devices, and systems for providing a new two-factor or user authentication procedure. A system includes a processor, a computer-readable storage medium, storing instructions which, when executed by the processor, cause the processor to perform operations including receiving a behavioral biometric pattern (BBP) associated with a user to be authenticated, operating an algorithm on the BBP to generate an output matrix, comparing the output matrix to a previously-obtained output matrix from a training BBP of a training user to yield a comparison and outputting, based on the comparison, a comparison result which can include an authentication of the user or an identification of the user.

### PRIORITY INFORMATION

The present application claim priority to U.S. Patent Provisional Application No. 63/274,818, filed Nov. 2, 2021, the content of which is incorporated herein in its entirety.

### TECHNICAL FIELD

The present disclosure generally relates to improvements in user authentication for access to systems and services and particularly to using behavioral biometrics and outputs processing behavioral biometrics through a model such as a neural network.

### BACKGROUND

Typically, generic neural networks such as those shown in FIGS. 1A and 1B can be used for binary classification. These networks are able to learn or be trained on a single user with neural network 100 in FIG. 1A having an input layer 102 with multiple features, hidden layers 104 and an output 106. This network feeds an entire pattern at once to generate an output. In FIG. 1B, the input layer 110 of the neural network 108 is one feature, with the hidden layers 104 processing character by character and generating the output 112. This network feeds a pattern one feature at a time.

There are problems with the above approach. The accuracy of the system is not strong. Improvements are not possible and it requires huge sets of single user data. Models such as non-neural networks can be used but they have high false rejection rates. Further, training models in this manner is computationally expensive requiring many compute cycles for either a central processing unit (CPU) as well as in some cases the use of a graphics processing unit (GPU). In addition, training happens on each device individually and it requires heavy feature engineering.

The approaches shown in FIGS. 1A and 1AB are prone to attacks because a messed-up input can lead to a large value on output. Finally, to train and retrain these networks, original patterns, and often the original raw data, need to be stored and used which can lead to privacy concerns.

### SUMMARY

The present disclosure generally relates to improvements in user authentication and particularly to utilizing typing characteristics of a text for authentication purposes. Note that the text disclosed herein differs from the user password in that the approach of evaluating the typing characteristics of reference text and is independent of a password analysis or matching operation.

What is needed in the art is an improvement with respect to the user authentication for enabling a user to access an application or a service. The disclosed approach addresses this problem. Systems and methods can be implemented using the principles disclosed herein. An example method for generating an output matrix or structure for use in authenticating new users can include one or more steps including receiving, at a system operating an algorithm, a behavioral biometric pattern (BBP) associated with a user, generating, via the system and based on the algorithm processing the BBP relative to an array of anonymized or artificially-generated user (AAGU) data, an output matrix representing a similarity between the user and the AAGU data and utilizing the output matrix to authenticate a new user providing new user BBP. The output matrix can include a similarity between the BBP and the AAGU data. The BBP can include mouse use patterns, pointer device use patterns, patterns associated with a user operating a trackpad, touchscreen or traditional keyboard. Other types of user interaction can be addressed as well such as multi-modal interactions, speech or other types of user input.

A system can include a processor and a computer-readable storage device storing instructions which, when executed by the processor, cause the processor to perform operations including generating an output matrix or structure for use in authenticating new users can include one or more steps including receiving, at the system operating an algorithm, a behavioral biometric pattern (BBP) associated with a user, generating, based on the algorithm processing the BBP relative to an array of anonymized or artificially-generated user (AAGU) data, an output matrix representing a similarity between the user and the AAGU data and utilizing the output matrix to authenticate a new user providing new user BBP.

Another example method can include receiving, at a system running an algorithm, a behavioral biometric pattern (BBP) associated with a user to be authenticated, operating the algorithm on the BBP to generate an output structure, comparing the output structure to a previously-obtained output matrix from a training BBP of a training user to yield a comparison and outputting, based on the comparison, a comparison result. The comparison can be one or more of a score, a binary classification, a class decision. The output structure can be AAGU, an output matrix or an output matrices, an internal or previous layer to an output layer, or any other abstraction associated with the machine learning/neural network that can be used to obtain similarities.

A system can include a processor and a computer-readable storage device storing instructions which, when executed by the processor, cause the processor to perform operations including receiving a behavioral biometric pattern (BBP) associated with a user to be authenticated, operating an algorithm on the BBP to generate an output structure, comparing the output structure to a previously-obtained output matrix from a training BBP of a training user to yield a comparison and outputting, based on the comparison, a comparison result. The comparison can be one or more of a score, a binary classification, a class decision. The output structure can be AAGU, an output matrix or an output matrices, an internal or previous layer to an output layer, or any other abstraction associated with the machine learning/neural network that can be used to obtain similarities.

A continuous authentication method can include receiving, at a first time, a first authentication of a user to use a computer system, based on the first authentication, setting a first time interval at which the user can continue to use the computer system, receiving, at a second time, a second authentication of the user to use the computer system, based on the second authentication, setting a second time interval at which the user can continue to use the computer system and, when the second time interval expires without a new authentication which would extend the authorization, performing a predetermined action. The continuous authentication method can also apply to a concept of continuous endpoint authentication where one or more endpoints in a communication can be tracked for unauthorized use.

A system related to the continuous authentication method can include a processor and a computer-readable storage device storing instructions which, when executed by the processor, cause the processor to perform operations including include receiving, at a first time, a first authentication of a user to use a computer system, based on the first authentication, setting a first time interval at which the user can continue to use the computer system, receiving, at a second time, a second authentication of the user to use the computer system, based on the second authentication and setting a second time interval at which the user can continue to use the computer system. When the second time interval expires without a new authentication which would extend the authorization, the operations can include performing a predetermined action. The continuous authentication method implemented by the system can also apply to a concept of continuous endpoint authentication where one or more endpoints in a communication can be tracked for unauthorized use.

A simplified version of the continuous authentication method can include, for any respective authentication operation, receiving an authentication of a user to use a computer system, based on the authentication, setting a time interval at which the user can continue to use the computer system and, when the time interval expires without a new authentication occurring which would extend the authorization, performing a predetermined action.

In one example, a system can include a behavioral biometric recorder for recording one or more of typing characteristics, mouse biometrics, touch input biometrics, or other behavioral or biometric data associated with a user to yield recorded data, an output matrices generator that generates non-behavioral characteristics based on operation of a model on the recorded data that show a similarity between an output matrices generated from the model based on the recorded data of the user and other user output matrices generated by the model based on other user data and a comparison module that compares the output matrices with the other user output matrices to generate a comparison score or authentication score. Other system elements can include an authentication module configured to run in time intervals to periodically extend an authentication expiration time and/or a watchdog module configured, when the authentication expiration time has expired, to perform a predetermined task.

The system can be a mobile device, a desktop computer, a laptop, a network-based server or cloud server, or any other computing device. Systems can also include combinations of these elements. In another aspect, the operations can occur in an offline mode in which the system is not connected to a network or the cloud or an online mode in which the system is a network-based server or is in communication with a network.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

Embodiments can also include systems or computer-readable media with instructions to control a processor to perform the functions disclosed herein. The foregoing, together with other features and embodiments, will become more apparent upon referring to the following specification, claims, and accompanying drawings.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example multiple-input neural network including an output matrix;

FIG. 1B illustrates an example single-input neural network including an output matrix;

FIG. 2A illustrates an example multiple-input neural network including an output matrix with multiple outputs;

FIG. 2B illustrates an example single-input neural network including an output matrix with multiple outputs;

FIG. 3 illustrates an example of the comparison of new user data versus two random users in two dimensions;

FIG. 4 illustrates new user data compared to ten random users;

FIGS. 5A-D illustrate various example methods, according to some aspects of this disclosure; and

FIG. 6 illustrates an example system or device according to some aspects of this disclosure.

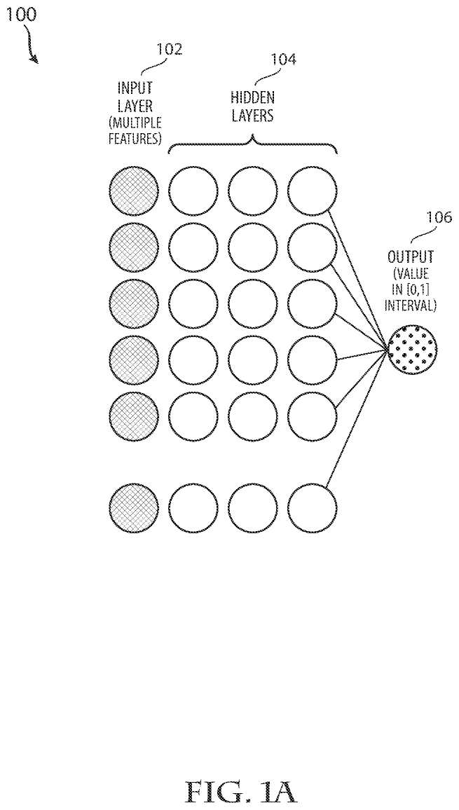

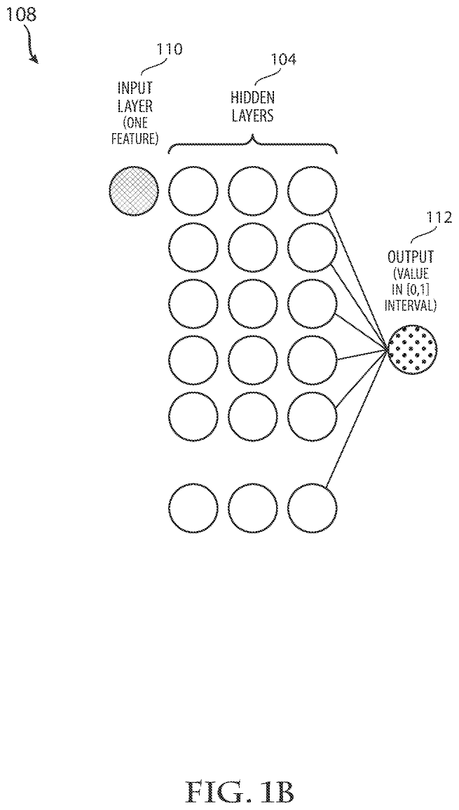

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

The disclosed solution includes a machine learning (ML) algorithm(s) used for authentication that is trained on behavioral biometrics patterns (BBP), such as typing patterns from a large array of anonymized or artificially generated users (AAGU) with the ability to process any new BBP and return an array of matching results against each of the anonymized users that the model was trained on. The output matrices or result is then matched against previously recorded similar data and returns a matching/authentication score or binary result. The BBP can include any pattern associated with how a user provides input to a computing device. For example, mouse use patterns, pointer device use patterns, patterns associated with a user operating a trackpad, touchscreen or traditional keyboard. Other patterns such as gestures or multi-model input characteristics can be used as well. For example, some input might include speech plus an interaction with a touch sensitive display such as a user saying “take me here” and pointing to or touching a virtual object showing a restaurant object on a touch-sensitive display. The input might just be speech as in how a user interacts with the “Siri” service by Apple to request a song or order something for purchase and delivery.

In one example, a keyboard is projected on a physical desktop and a user simply touches the location on the desktop where a letter is projected. This requires user gestures that are sensed by the device to translated into a particular key touch. Other gestures may be made in the air such as through sign language or other gestures that can be detected. Facial motion or movement can also be a gesture that can be modeled. The system may provide separate models for each different modality that is used for providing user input. Further, as noted above, the modeling may also include multi-modal inputs that combine at least two and perhaps more different input modalities to achieve a task.

Note that while behavioral biometrics patterns are described herein as one example of the type of data processed by the models to generate the output matrix, any type of data could also be applied to the principles disclosed herein. Thus, the process could be used, for example, to classify medical images, or predict weather patterns, and so forth. The data used can be characterized generally as data and more specifically in terms of BBP as one example of the type of data that can be input to the input layer and processed and then output.

Technically, the algorithm is trained to identify one of the anonymized or artificially generated users in the training set, when their BBP is sent to the algorithm. The ML models are thus trained typically on one or more users and their BBP data. However, after training these ML models, when the BBP of a new user (NU) is processed, the ML model will produce a set of scores (output matrices) with very high similarity for most BBP of NU. Therefore, the output is potentially used for authentication and even identification, and can act as a transformation that has multiple benefits.

Some of the benefits include that BBPs are not required to be stored/used for comparison. This provide improved privacy over previous approaches. A continuous authentication system can use the transformation array data for both learning the user (as a set of gaussian distribution of matches against the AAGU) and to continuously verify the user's new BBPs against the learned BBPs as disclosed herein. The concepts disclosed herein can also apply to continuous endpoint authentication as well.

The system disclosed herein is very hard to break because each AAGU is picked to have similar chances to get low and high scores for any given NU. Therefore, a master key BBP cannot be conceived. This is unlike other biometric authentication systems that train individually for each user which are known to have such weaknesses (e.g., DeepMasterPrints attack on fingerprint recognition systems). Another benefit is that accuracy increases indefinitely with the number of AAGU, which act as non-behavioral dimensions for each user. The only expense is that the network becomes less efficient in terms of computation, but actual limits are probably only in the millions of AAGU.

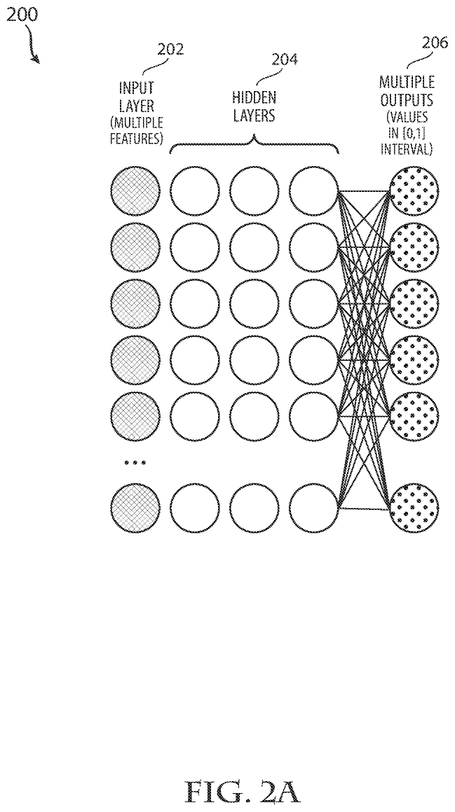

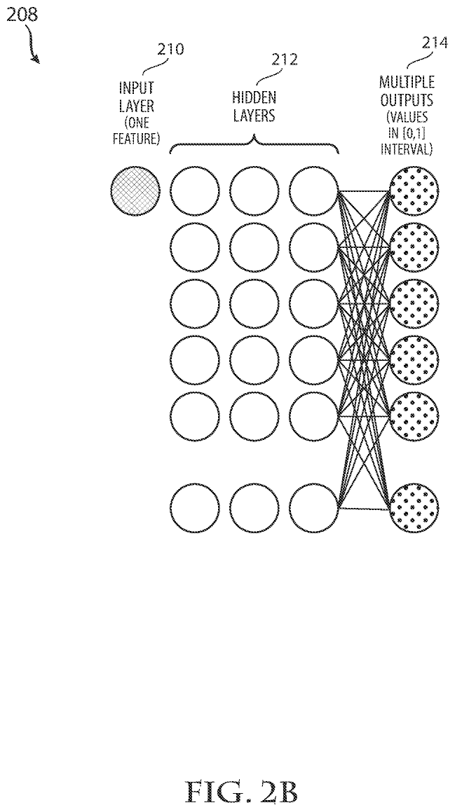

The approach disclosed herein can be characterized as a repurposing of multi-user/multi-class neural networks for binary classification or for authentication. The idea is that instead of training and comparing actual user models, the system uses agnostic existing trained models that identify different users based on the same type of input (biometric pattern/BBP or other type of data). In theory, this method uses models trained to identify a limited number of users (outputs) with high error. In practice, this acts as a similarity method, that shows how similar any new user (any unseen user) is to each of the users trained/used as outputs. With enough of these outputs, input samples from the same user should get very similar output values per each output. Therefore, the output matrices can be compared for authentication purposes (and generally for binary classification). FIG. 2A illustrates a neural network 200 with a multiple feature input layer 202, hidden layers 204 and a multiple-output structure 206. The output matrices 206 are used in novel ways as disclosed herein to authenticate a user or identify a user.

FIG. 2B illustrates a single feature input layer 210 of a neural network 208 with the hidden layers 212 and a multiple-output matrices 214. Methods of comparing outputs for authentication can be simple or more complex. The idea is to compare a new output having its data processed by the model 200, 208 to existing or trained outputs and return an average/sum or other metric that shows similarity between the new output and the trained output. The output or the results of the comparison can be used for authentication or binary classification. For example, horizontally new output values can be measured against existing output values and their distributions, which produces so-called z-scores (how far a sample is from a statistical distribution). The average of the z-scores can be used as a metric for authentication. Vertically, measures like cosine-similarity or other mathematical similarity measures can be used to compare a new output matrix to previous output matrices. Machine learning models can be trained to perform these comparisons, with potentially better results than simple similarity measures. Combinations of comparison methods can also be used. The goal of the comparison method is to use output matrices as one would use input samples in a binary classification that can be statistical, or machine learning based.

A number of different algorithms can be used, all taking advantage of this same method that can include two phases (A, and B, which can be combined in one larger phase). Phase A relates to output matrix generation. As input, the system can receive a user's BBP. The output can be an output matrix (an array of AAGU matching scores) 206, 214. These output values represent the similarity between the user and the AAGU and are used for both learning the user and for the actual authentication against the learned user data. Phase B relates to the comparison operation using a trained or learned user data and can have as an input a new output matrix (phase A output) and a previous user's learned data such as previous output matrices. The output of phase B is a comparison result, or an authentication result (score, binary, class, etc.).

The output matrix described herein can also be any output structure which may or may not be an output matrix. For example, the output structure could be AAGU or one or more of a previous layer to an output layer of a machine learning/neural network. Other abstractions associated with or present within the machine learning/neural network can also be used for comparison and to represent the similarities described herein.

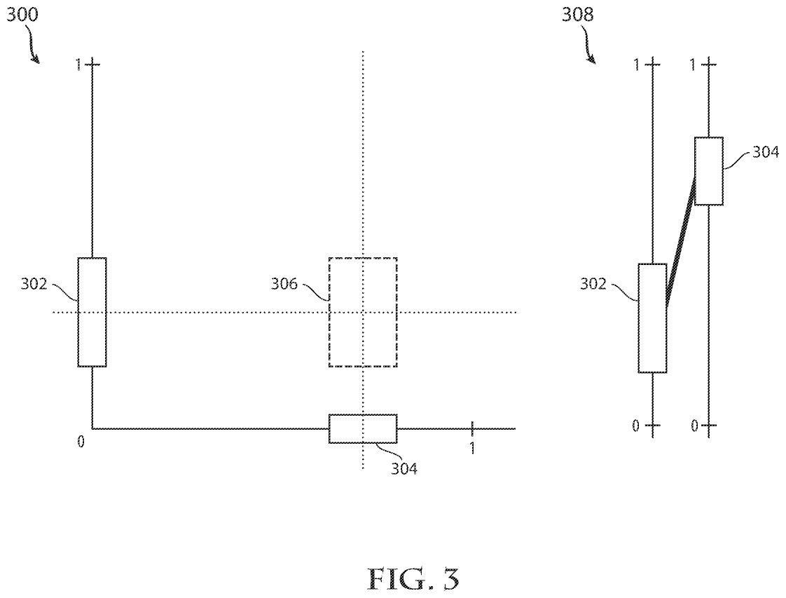

FIG. 3 illustrates a graph 300 of a representation of new user data 302, 304 related to two random users 306 and data provided in two dimensions. Another representation 308 is shown as well with the first set of user data 302 and the second set of user data 304 represented as a range of values between 0 and 1. This gives an example of how the comparison can occur across ranges of data represented as features 302, 304.

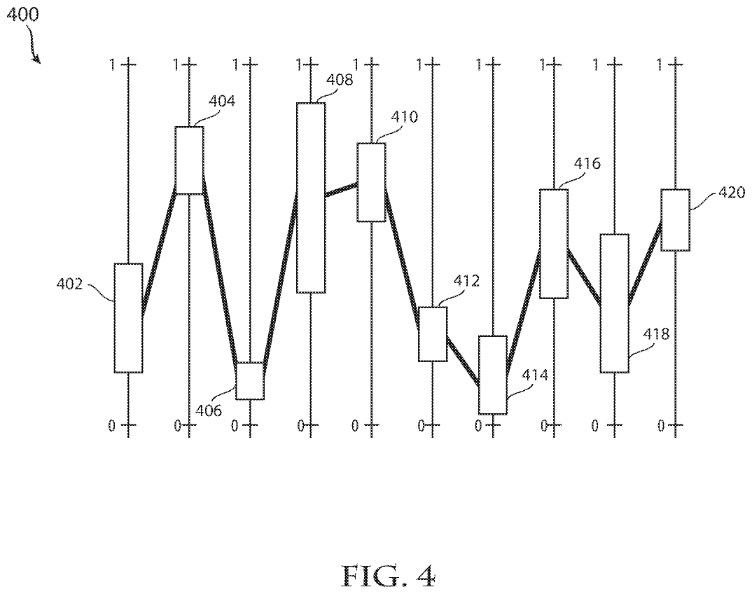

FIG. 4 illustrates a comparison graph 400 of a new user to ten random users with various pieces of data 402, 404, 406, 408, 410, 412, 414, 416, 418 and 420. The output comparison can be used or “trained” to identify between multiple users. Again, each of these data can represent a range of values for that particular parameter which can be used to compare the new data against the trained data to see if, with respect to the particular user or the particular parameter, the new data is within the range, or whether it is outside of the range.

The benefit of this approach is that it improves accuracy of the classification or authentication. As more users are trained on the system, more dimensions (see FIG. 4) can be applied to improve accuracy. The main machine learning models can be easily trained (on artificial data in one example) and the process only requires soft engineering. Manipulating the input in this case would not result in the correct diagram on the output to break or identify the user. Furthermore, there is no need to store or use original typing or input patterns, only output statistics need to be stored or used for future authentication.

The behavioral biometrics pattern (BBP) can be agnostic in terms of what a behavioral biometrics pattern is. Depending on model architecture, the model can take anything from raw data to complex data engineered patterns including visual representations, descriptive statistics, ratios, compounded measures or other measures that are characteristic for a particular user's behavior. For example, in typing biometrics, typing patterns may consist of absolute or relative key press and key release timings stored for each key, char, keycode, physical position, touch screen position, as well as compounded measurements that can be any time measurements of combinations of any two or more keys. Typically, basic times can be used such as DownKey1-UpKey1 (known as dwell time), DownKey2-UpKey2, DownKey1-DownKey2 (known as flight time), DownKey1-UpKey2, UpKey1-DownKey2, UpKey1-UpKey2, etc) or compounded measurements of the basic times taken together, ranks, ratios, various differences, descriptive statistics, distribution statistics, or other more complex combinations/formulas that use the basic times. These times can apply to any type of input. For example a flight time or dwell time might relate to test input, speech input, gesture input or multi-modal input.

Other non-standard characteristics for typing biometrics can be the keyboard sounds associated with the typing activity, telemetry data such as accelerometer and gyroscope data associated with the action of typing on the keyboard, pressure, touch data and any other sensory data that can be associated with the typing activity. For the purpose of this disclosure, the concept is extended and the definition of a key can be as any XY-position, and any defined areas on the touch screen or physical keyboard that are not necessarily limited to exactly a key on the keyboard but can take any shape and size and include less or more than one individual key.

For example, in mouse biometrics, or touch screen/touch pad biometrics, the BBP usually consists of absolute and relative times and coordinates, direct and total distances, movement angles, accelerations, decelerations, speeds between any two mouse/finger events (startmove, changemove, drag, stop, press, release, click, doubleclick), or even pressure data, finger size, and finger angle. These various inputs can all be used raw or data engineered in various formats easier to store and/or process by some algorithms.

Any biometrics pattern can be used as BBP as disclosed herein. The method described hereby can also be applied to any type of biometric, any type of user data that is descriptive enough for the user to be matched against various other users. For example, the same method can be applied to images/recorded patterns of face, fingerprint, voice, DNA, iris, fingers, palm, vein, and similar. Again, the data may also be completely different and relate to something like medical images, weather patterns, financial data, or any other type of data that is applicable to be classified.

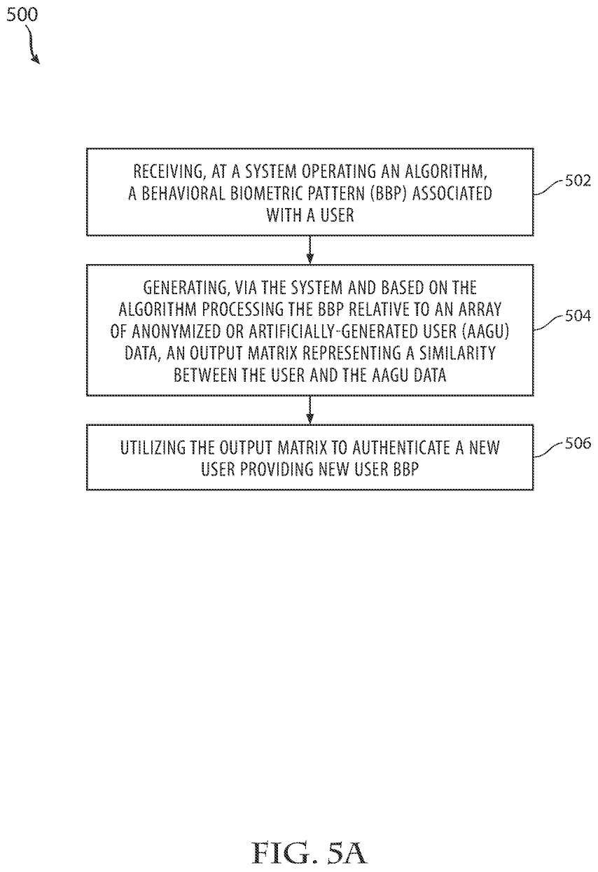

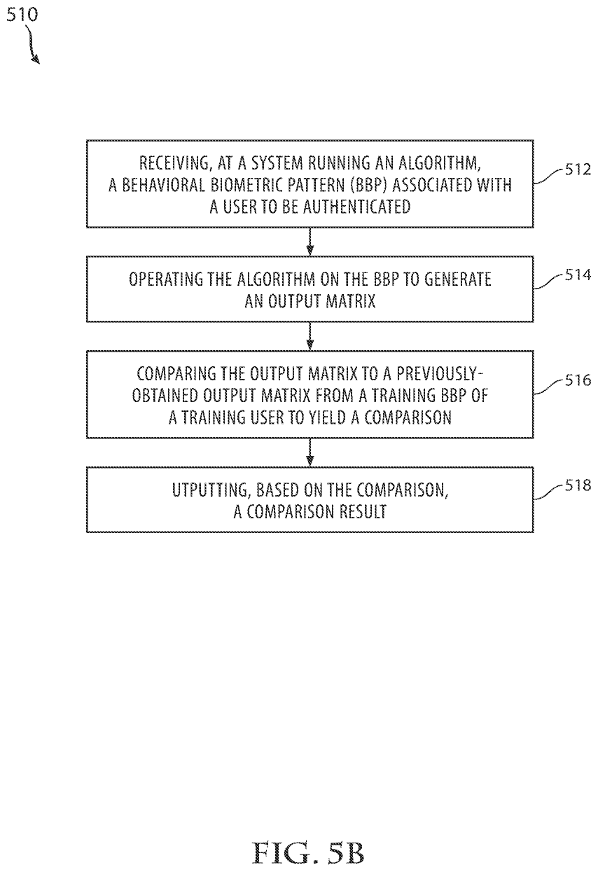

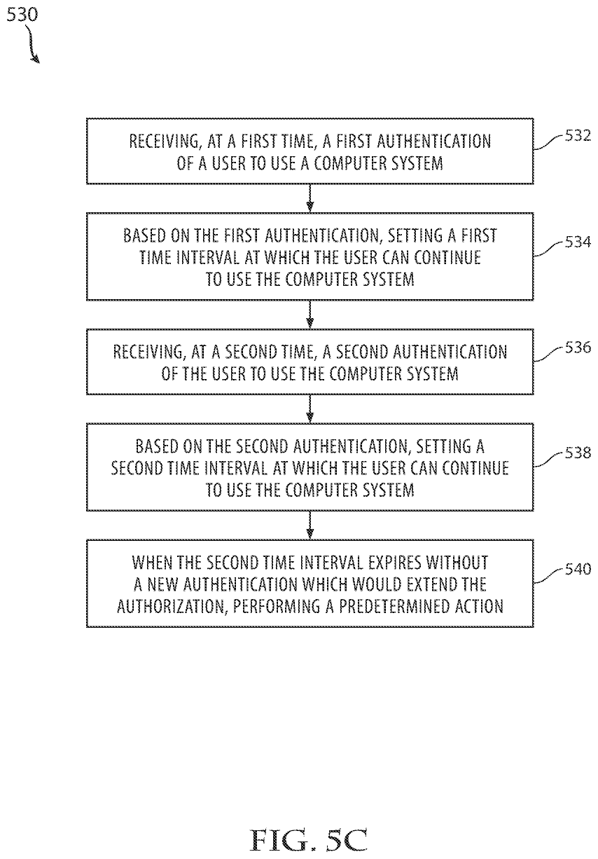

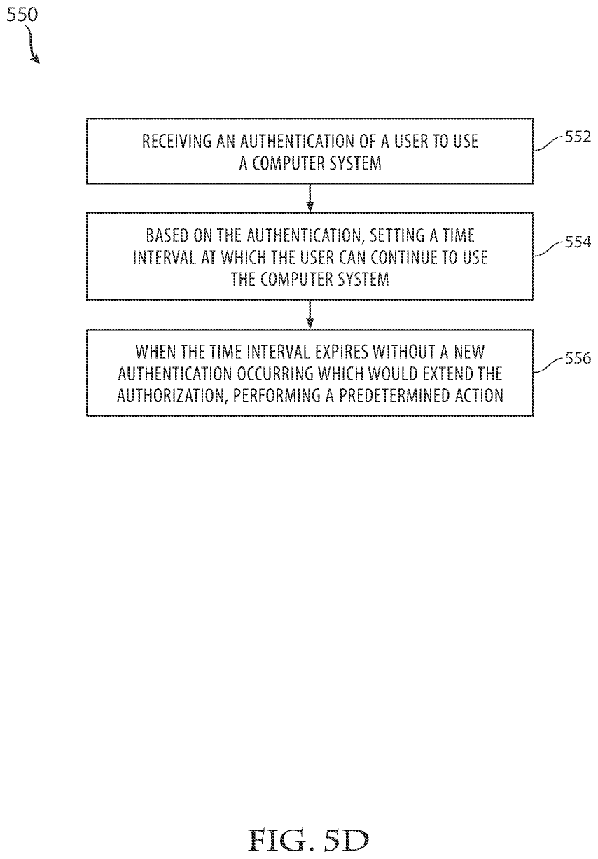

FIG. 5A illustrates a method 500 of generating the primary output matrix used to compare output matrices from new user data. The method 500 can include receiving, at a system operating an algorithm, a behavioral biometric pattern (BBP) associated with a user (502), generating, via the system and based on the algorithm processing the BBP relative to an array of anonymized or artificially-generated user (AAGU) data, an output matrix (or output data) representing a similarity between the user and the AAGU data (504) and utilizing the output matrix to authenticate a new user providing new user BBP (506). The output matrix can include a similarity between the BBP and the AAGU data. The algorithm operating on the system can be one of a machine learning algorithm, an artificial intelligence algorithm and a neural network having at least an input layer, none, one or more hidden layers and an output layer. In a continuous endpoint authentication approach, data can be logged on a device and/or on a log aggregation platform in the case of a suspected unauthorized user. Remedial actions can be triggered from a device or from the platform to shut down the device or endpoint quarantine the device or take some other action.

FIG. 5B illustrates another method 510 including receiving, at a system running an algorithm, a behavioral biometric pattern (BBP) associated with a user to be authenticated (512), operating the algorithm on the BBP to generate an output matrix (514), comparing the output matrix to a previously-obtained output matrix from a training BBP of a training user to yield a comparison (516) and outputting, based on the comparison, a comparison result (518). The comparison can include one or more of a score, a binary classification, a class decision. The algorithm can include one of a machine learning algorithm, an artificial intelligence algorithm and a neural network having at least an input layer, none, one or more hidden layers and an output layer. In another aspect, the BBP can be one or more of a key press pressure, a key release timing, a compound measurement related to multiple key presses, and other key press characteristics.

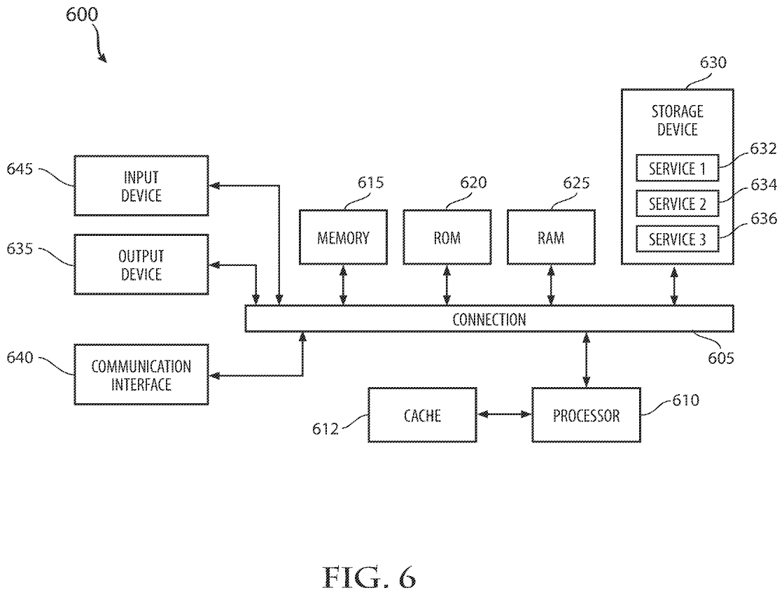

A system 600 can be presented by the components disclosed in FIG. 6 which can include various hardware and/or software modules. The system can include a behavioral biometric recorder for recording one or more of typing characteristics, mouse biometrics, or other behavioral or biometric data associated with a user to yield recorded data and an output matrices generator that generates non-behavioral characteristics based on operation of a model on the recorded data that show a similarity between an output matrices generated from the model based on the recorded data of the user and other user output matrices generated by the model based on other user data.

Other modules can include a comparison module that compares the output matrices with the other user output matrices to generate a comparison score or authentication score, an authentication module configured to run in time intervals to periodically extend an authentication expiration time; and a watchdog module configured, when the authentication expiration time has expired, to perform a predetermined task. The system can include any one or more of these modules and different systems.

Note as well that the output matrices represent an example data structure that is used for comparison. The data that can be used for comparison can be different as well. For example, the AAGU could be used for comparison. Data associated with previous layers rather than just the output layer could be the structure used for comparison. Other abstractions from the data or that are present in the ML/neural network could be used to represent the similarities or could be used in the comparison for identification.

Another aspect of this disclosure addresses a continuous authentication system, which can relate to the watchdog module introduced above. At a fixed time interval or at a variable or dynamic time interval, a full behavioral biometrics authentication process is started which results in an authentication score as described above. If the authentication score is within acceptable limits, a new expiration date is set further, effectively authenticating the user for another interval. For example, a “use license” could be granted, based on a respective authentication, for a period of 10 minutes. The license could also be provided for 10 minutes of active use of the system. For example, if the user is authenticated and then steps away for 5 minutes, and then comes back and works for 10 minutes, the extension of time would be a total of 15 minutes. There are various ways in which the use license could be granted and how the timing of the license could be determined.

If there is not enough new data to conduct the authentication, the authentication license can/will be automatically extended (e.g. if the user didn't type from last authentication). A separate time interval-based watchdog module watches for the expiration of last authentication. If a respective authentication has expired/has not been renewed, it performs the desired preselected task (locks the screen, sends an alert/notification, prompts for manual authentication, prevents access to a computing system, etc.).

Note that authentication of a user over time might also switch modes such as a first period of time or authentication based on typing patterns followed by a multi-modal input authentication. This can also apply to the continuous authentication approach below in which the process is continuous but changes input modalities over time.

FIG. 5C illustrates a continuous authentication approach. A method 530 can include receiving, at a first time, a first authentication of a user to use a computer system (532), based on the first authentication, setting a first time interval at which the user can continue to use the computer system (534), receiving, at a second time, a second authentication of the user to use the computer system (536), based on the second authentication, setting a second time interval at which the user can continue to use the computer system (538) and, when the second time interval expires without a new authentication which would extend the authorization, performing a predetermined action (540).

Note that two iterations are described in the example, but any one or more time extensions can be granted and then if it expires, then the action is taken such as shutting the user out from accessing the system.

A system aspect can include a processor and a computer-readable storage medium, storing instructions which, when executed by the processor, cause the processor to perform operations. The operations can include one or more of receiving, at a first time, a first authentication of a user to use a computer system; based on the first authentication, setting a first time interval at which the user can continue to use the computer system; receiving, at a second time, a second authentication of the user to use the computer system; based on the second authentication, setting a second time interval at which the user can continue to use the computer system; and, when the second time interval expires without a new authentication which would extend the authorization, performing a predetermined action.

Various ideas are introduced above. Note that the idea of repurposed multi-user/multi-class neural networks for binary classification is introduced. This is a separate idea from the continuous authentication approach shown above. Behavioral biometric patterns can be used herein for authentication, and/or also for the continuous authentication approach. Any type of biometrics can be used for authentication and/or continuous authentication. In one aspect, a first authentication is achieved using a first type of biometric and then a continuous authentication can use a different type or different arrangement of biometric parameters.

Another aspect can include a concept of continuous endpoint authentication in which an endpoint associated with a communication between devices can continuously be authenticated. If an unauthorized user is suspected of having access to an endpoint, data associated with the user of the endpoint (typing, other use input) can be logged on the device and/or in a cloud-service such ad DataDog, Grafana, Splunk, Humio and so forth. Any log aggregation platform can perform this task. From the device or from a network-based platform, future decisions and alerts can be triggered. The decisions can be limited or focused in scope. For example, a decision might be triggered at a device level to quarantine the device via an application such as Crowdstrike Falcon or any other application that quarantines the device. In another aspect, the online or network-based platform that has access to the logged data might initiate a function based on a suspected unauthorized user. The logging of data on the device or in a network platform can occur in parallel with locking the device in the case of a suspected unauthorized user.

FIG. 5D illustrates another aspect of the continuous authentication process. The method 550 can include receiving an authentication of a user to use a computer system (552), based on the authentication, setting a time interval at which the user can continue to use the computer system (554) and, when the time interval expires without a new authentication occurring which would extend the authorization, performing a predetermined action (556). The iteration of FIG. 5D can be the first, second, third or any one of a number of authentication steps in which a new time interval is set for a license or authorization to access or keep using the system. The time period can be fixed or can be dynamic. For example, a stronger authentication score can cause a longer license period. A weaker score can cause a reduced time period for a license. Other data can be used such as a time of day, which day of the week, current events, or personal data about the user being authenticated (is it their birthday or anniversary, or is it a holiday that they celebrate) can also be used to determine a time period of a license.

A system can include a processor and a computer-readable storage medium, storing instructions which, when executed by the processor, cause the processor to perform operations. The operations can include receiving an authentication of a user; based on the authentication, setting a time interval at which the user can continue to a computer system; and, when the time interval expires without a new authentication occurring which would extend the authorization, performing a predetermined action. The predetermined action can include preventing the user from having access to the computer system.

The system as disclosed herein can include a mobile device, a desktop computer, a laptop computer, a network-based server or any other computing device. The operations or methods disclosed herein can be performed in one of an offline mode in which the system does not have a connection to a network and an online mode in which the system is connected to a network. The system can be connected to “the cloud” or a set of software and/or hardware servers and capabilities accessible through the Internet or other network. Some examples of cloud services include Google Drive, Apple iCloud, Amazon Cloud Drive, Netflix, Yahoo Mail, Dropbox and Microsoft OneDrive. The operations disclosed herein can be accessible through the cloud. The services can be accessed also through wired communication channels or at least in part a wireless communication channel through any wireless protocol such as WiFi, Bluetooth, 4G, 5G, and so forth.

FIG. 6 illustrates an example computer system 600 for implementing a part of the instant disclosure. For example, the example computer system 600 may execute a client application for performing the instant disclosure. The example computer system 600 includes a processor 605, a memory 610, a graphical device 615, a network device 620, interface 625, and a storage device 630 that are connected to operate via a bus 635. The processor 605 reads causes machine instructions (e.g., reduced instruction set (RISC), complex instruction set (CISC), etc.) that are loaded into the memory 610 via a bootstrapping process and executes an operating system (OS) for executing application within frameworks provided by the OS. For example, the processor 605 may execute an application that executes an application provided by a graphical framework such as Winforms, Windows Presentation Foundation (WPF), Windows User Interface (WinUI), or a cross platform user interface such as Xamarin or QT. In other examples, the processor 605 may execute an application that is written for a sandbox environment such as a web browser.

A module can be programmed with instructions stored in memory to control a processor to perform specific operations. So programmed, the computer becomes a special purpose computer specifically programmed to perform functions.

The processor 605 controls the memory 610 to store instructions, user data, operating system content, and other content that cannot be stored within the processor 605 internally (e.g., within the various caches). The processor 605 may also control a graphical device 615 (e.g., a graphical processor) that outputs graphical content to a display 640. In some example, the graphical device 615 may be integral within the processor 605. In yet another example, the display 640 may be integral with the computer system 600 (e.g., a laptop, a tablet, a phone, etc.).

The graphical device 615 may be optimized to perform floating point operations such as graphical computations, and may be configured to execute other operations in place of the processor 605. For example, the processor 605 can be controlled by instructions to perform mathematical operations optimized for floating point math. For example, the processor 605 may allocate instructions to the graphical device 615 for operations that are optimized for the graphical device 615. For instance, the graphical device 615 may execute operations related to artificial intelligence (AI), natural language processing (NLP), vector math, etc. The results may be returned to the processor 605. In another example, the application executing in the processor 605 may provide instructions to cause the processor 605 to request the graphical device 615 to perform the operations. In other examples, the graphical device 615 may return the processing results to another computer system (i.e, distributed computing).

The processor 605 may also control a network device 620 that transmits and receives data using a plurality of wireless channels 645 and at least one communication standard (e.g., Wi-Fi (i.e., 802.11ax, 802.11e, etc.), Bluetooth®, various standards provided by the 3rd Generation Partnership Project (e.g., 3G, 4G, 5G), or a satellite communication network (e.g., Starlink). The network device 620 may wirelessly connect to a network 650 to connect to servers 655 or other service providers. The network device 620 may also be connected to the network 650 via a physical (i.e., circuit) connection. The network device 620 may also directly connect to local electronic device 660 using a point-to-point (P2P) or a short range radio connection.

The processor 605 may also control an interface 625 that connects with an external device 670 for bidirectional or unidirectional communication. The interface 625 is any suitable interface that forms a circuit connection and can be implemented by any suitable interface (e.g., universal serial bus (USB), Thunderbolt, and so forth). The external device 665 is able to receive data from the interface 625 to process the data or perform functions for different applications executing in the processor 605. For example, the external device 665 may be another display device, a musical instrument, a computer interface device (e.g., a keyboard, a mouse, etc.), an audio device (e.g., an analog-to-digital converter (ADC), a digital-to-analog converter (DAC)), a storage device for storing content, an authentication device, an external network interface (e.g., a 5G hotspot), a printer, and so forth.

It is noted that in one aspect, the steps disclosed herein can be practiced by a “system.” The system can include the server and one or more clients together or might just be functionality performed by the server. The system could also be a client or a group of clients, such as clients in a particular geographic area or clients grouped in some manner that are performing the client-based functions disclosed herein. Claims can be included which outline the steps that occur from the standpoint of any device disclosed herein. For example, the steps of transmission and receiving of data can be claimed from the standpoint of a server device, a client device, or group of client devices depending on which embodiment is being covered. All such communication from the standpoint of an individual component or device can be included as within the scope of a particular embodiment focusing on that device.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

The biometric data described above relates to typing patterns for users, but other biometrics such as fingerprint recognition, facial recognition, voice recognition can also be blended in with the typing patterns or BBP described for authentication purposes. Such other biometric data can also replace the typing patterns as well. Any mixture of biometric data can be used for authentication according to the principles described above.

Claim language reciting “at least one of” a set indicates that one member of the set or multiple members of the set satisfy the claim. For example, claim language reciting “at least one of A and B” means A, B, or A and B.

What is claimed is:

1. A method comprising:
receiving, at a system operating an algorithm, a behavioral biometric pattern (BBP) associated with a user;
generating, via the system and based on the algorithm processing the BBP relative to an array of anonymized or artificially-generated user (AAGU) data, an output structure representing a similarity between the user and the AAGU data; and
utilizing the output structure to authenticate a new user providing new user BBP.

2. The method of claim 1, wherein the output structure comprises a similarity between the BBP and the AAGU data.

3. The method of claim 1, wherein the algorithm operating on the system comprises at least one of a machine learning algorithm, an artificial intelligence algorithm and a neural network having at least an input layer, none, one or more hidden layers and an output layer.

4. The method of claim 3, wherein the output structure comprises one of an output matrix from the algorithm, a modified AAGU or data associated with any layer associated with the algorithm.

5. A system comprising:
a processor;
a computer-readable storage medium, storing instructions which, when executed by the processor, cause the processor to perform operations comprising:
receiving a behavioral biometric pattern (BBP) associated with a user;
generating, based on an algorithm processing the BBP relative to an array of anonymized or artificially-generated user (AAGU) data, an output structure representing a similarity between the user and the AAGU data; and
utilizing the output structure to authenticate a new user providing new user BBP.

6. The system of claim 5, wherein the output structure comprises one of an output matrix from the algorithm, a modified AAGU or data associated with any layer associated with the algorithm.

7. A method comprising:
receiving, at a system running an algorithm, a behavioral biometric pattern (BBP) associated with a user to be authenticated;
operating the algorithm on the BBP to generate an output structure;
comparing the output structure to a previously-obtained output structure from a training BBP of a training user to yield a comparison; and
outputting, based on the comparison, a comparison result.

8. The method of claim 7, wherein the output structure comprises one of an output matrix from the algorithm, a modified AAGU or data associated with any layer associated with the algorithm.

9. The method of claim 7, wherein the comparison comprises one or more of a score, a binary classification, a class decision.

10. The method of claim 7, wherein the algorithm comprises at least one of a machine learning algorithm, an artificial intelligence algorithm and a neural network having at least an input layer, none, one or more hidden layers and an output layer.

11. The method of claim 7, wherein the BBP comprises one or more of a key press pressure, a key release timing, a compound measurement related to multiple key events, and other key event related characteristics.

12. A system comprising:
a processor;
a computer-readable storage medium, storing instructions which, when executed by the processor, cause the processor to perform operations comprising:
receiving a behavioral biometric pattern (BBP) associated with a user to be authenticated;
operating an algorithm on the BBP to generate an output structure;
comparing the output matrix to a previously-obtained output structure from a training BBP of a training user to yield a comparison; and
outputting, based on the comparison, a comparison result.

13. A system comprising:
a behavioral biometric recorder for recording one or more of typing characteristics, mouse biometrics, touch input biometrics, or other behavioral or biometric data associated with a user to yield recorded data;
an output matrices generator that generates non-behavioral characteristics based on operation of a model on the recorded data that show a similarity between an output matrices or structure generated from the model based on the recorded data of the user and other user output matrices or structure generated by the model based on other user data;
a comparison module that compares the output matrices or structure with the other user output matrices or structure to generate a comparison score or authentication score;
an authentication module configured to run in time intervals to periodically extend an authentication expiration time; and
a watchdog module configured, when the authentication expiration time has expired, to perform a predetermined task.

14. A method comprising:
receiving, at a first time, a first authentication of a user to use a computer system;
based on the first authentication, setting a first time interval at which the user can continue to use the computer system;
receiving, at a second time, a second authentication of the user to use the computer system;
based on the second authentication, setting a second time interval at which the user can continue to use the computer system; and
when the second time interval expires without a new authentication which would extend the authorization, performing a predetermined action.

15. A system comprising:
a processor; and
a computer-readable storage medium, storing instructions which, when executed by the processor, cause the processor to perform operations comprising:
receiving, at a first time, a first authentication of a user to use a computer system;
based on the first authentication, setting a first time interval at which the user can continue to use the computer system;
receiving, at a second time, a second authentication of the user to use the computer system;
based on the second authentication, setting a second time interval at which the user can continue to use the computer system; and
when the second time interval expires without a new authentication which would extend the authorization, performing a predetermined action.

16. The system of claim 15, wherein the system comprises one of a mobile device, a desktop computer, a laptop computer or a network-based server.

17. The system of claim 15, wherein the operations are performed in one of an offline mode in which the system does not have a connection to a network and an online mode in which the system is connected to a network.

18. A method comprising:
receiving an authentication of a user to use a computer system;
based on the authentication, setting a time interval at which the user can continue to use the computer system; and
when the time interval expires without a new authentication occurring which would extend the authorization, performing a predetermined action.

19. The method of claim 15, wherein the predetermined action comprises preventing the user access to the computer system.

20. A system comprising:
a processor; and
a computer-readable storage medium, storing instructions which, when executed by the processor, cause the processor to perform operations comprising:
receiving an authentication of a user;
based on the authentication, setting a time interval at which the user can continue to a computer system; and
when the time interval expires without a new authentication occurring which would extend the authorization, performing a predetermined action.

21. The system of claim 20, wherein the predetermined action comprises preventing the user from having access to the computer system.

22. A system comprising:
a behavioral biometric recorder for recording one or more of typing characteristics, mouse biometrics, touch input biometrics, or other behavioral or biometric data associated with a user to yield recorded data;
an output matrices generator that generates non-behavioral characteristics based on operation of a model on the recorded data that show a similarity between an output matrices generated from the model based on the recorded data of the user and other user output matrices generated by the model based on other user data; and
a comparison module that compares the output matrices with the other user output matrices to generate a comparison score or authentication score.

23. The system of claim 22, wherein the system comprises one of a mobile device, a desktop computer, a laptop computer or a network-based server.

24. The system of claim 22, wherein the system operations in one of an offline mode in which the system does not have a connection to a network and an online mode in which the system is connected to a network.
